(19) United States
(12) Patent Application Publication
(10) Pub. No.: US 2010/0268187 A1
(43) Pub. Date: Oct. 21, 2010

(54) PACKAGING FOR SIROLIMUS AND COMPOSITION THEREOF

(75) Inventors: Ajay K. SINGLA, Chandigarh (IN); Sachin Arora, Gurgaon (IN); Mohit Mittal, Faridabad (IN)

Correspondence Address: Ranbaxy Inc., Intellectual Property Department, 600 College Road East, PRINCETON, NJ, 08540, US

(73) Assignee: Ranbaxy Laboratories Limited, New Delhi (IN)

(21) Appl. No.: 12/762,143

(22) Filed: Apr. 16, 2010

(30) Foreign Application Priority Data
Apr. 17, 2009 (IN) 800/DEL/2009

(51) Int. Cl. A61J 1/10; A61J 1/14; B65B 31/00

(52) U.S. Cl. 604/408; 604/403; 53/403

(57) ABSTRACT

The present invention relates to a packaging kit used for the stabilization of sirolimus particles wherein the packaging kit is in the form of a vacuum sealed impermeable container. It further relates to a method for stabilization of sirolimus particles as well as composition comprising the particles.

### FIELD OF THE INVENTION

The present invention relates to a packaging kit used for stabilization of sirolimus particles wherein the packaging kit is in the form of a vacuum sealed impermeable container. It further relates to a method for stabilization of sirolimus particles as well as a composition comprising the particles.

### BACKGROUND OF THE INVENTION

Sirolimus is a macrolide antibiotic produced by Streptomyces hygroscopicus and was discovered first for its properties as an antifungal agent. It adversely affects the growth of fungi such as Candida albicans and Microsporum gypseum. Sirolimus, its preparation and its antibiotic activity were described in U.S. Pat. No. 3,929,992. Later, in U.S. Pat. No. 5,100,899, use of sirolimus to inhibit transplant rejection in mammals was disclosed.

Sirolimus has poor oil and water solubility, hence poses significant problems in formulating the drug into a suitable dosage form. In addition, sirolimus is susceptible to oxidative degradation in the presence of oxygen and iron based colorants which act as Lewis acids. It was observed that there was an increase in the amount of group II impurities formed with increase in temperature. Oxidative impurities are formed by the oxidation across the triene portion of the molecule.

U.S. Pat. No. 5,145,684 discloses a nanoparticulate composition comprising particles consisting of a poorly soluble drug having adsorbed onto the surface of a non-crosslinked surface stabilizer, wherein the effective average particle size of the drug substance is less than about 400 nm.

It is known in the art that particle size reduction, particularly to extremely small sizes (less than 10 micron), could many a times lead to rapid degradation of the drug when exposed to heat, humidity and oxygen due to increased the surface area. In the case of sirolimus too, micronization increases the chances of degradation, leading to the reduction in the quality of the product upon storage.

European Patent No. 1,586,338 reports controlling oxidative degradation in sirolimus formulations by the addition of antioxidants such tocopherol. It discloses a medical device comprising an antioxidant mixed with sirolimus in order to hinder the degradation through oxidation. The marketed dosage form of sirolimus, RAPAMUNE® tablets also comprise an antioxidant.

However, the use of anti-oxidants is limited by several factors, including regulatory requirements, and there still exists a need to provide a method for stabilizing sirolimus particles and minimizing degradation.

We have now developed a stabilized sirolimus particles by using a packaging kit in the form of vacuum sealed impermeable container.

### SUMMARY OF THE INVENTION

According to one aspect of the present invention, there is provided a packaging kit useful for the stabilization of sirolimus particles, wherein the packaging kit is in the form of a vacuum sealed impermeable container.

In another aspect, there is provided a method for stabilization of sirolimus particles comprising the steps of:
a. packaging the sirolimus particles in an impermeable container; and
b. vacuum sealing the impermeable container.

In another aspect, there is provided a packaging kit used for the stabilization of a pharmaceutical composition comprising sirolimus particles wherein the packaging kit is in the form of vacuum sealed impermeable container.

In another aspect, there is provided a method for the stabilization of sirolimus particles comprising the steps of:
a. packaging a pharmaceutical composition comprising the sirolimus particles in an impermeable container; and
b. vacuum sealing the impermeable container.

### DETAILED DESCRIPTION

We have now developed a vacuum sealed packaging kit for packing sirolimus particles wherein the vacuum packed system retards degradation in general, and in particular the oxidative degradation of micronized sirolimus particles.

The term “sirolimus” as employed herein includes amorphous or crystalline form of the drug. The crystalline form may include polymorph form I or II or mixtures thereof.

The term “sirolimus particles” as used herein includes particles having d₉₀value of less than 10 μm. Particle size reduction may be carried out using micronization techniques such as dry milling technique or supercritical fluid technique. The particle size analysis may be carried using light-scattering methods, in particular, Malvern mastersizer.

The term “stabilization of sirolimus particles” as used herein means stabilization of sirolimus particles, which when subjected to stability studies at 25° C. and 60% RH for three months do not have more than 0.75% w/w of unknown impurities, as determined by High Performance Liquid Chromatography.

The impermeable container may be made up of oxygen as well as moisture impermeable material so that vacuum created during packaging is maintained throughout the shelf life of the drug or composition.

The impermeable container may be made up of impermeable material such as bi-axially oriented polypropylene (BOPP), polyester such as PET (polyethylene terpthalate), oriented polyamide (OPA), aluminum foil, or a combination of these polymers or a laminated structure of these polymers. Also, the impermeable container may be made up of a laminated structure comprising impermeable material and permeable material such as polyethylene. Possible structure of the laminates are PET/aluminum foil/PET/PE or PET/PE.

The impermeable container may be in the form of a bag, pouch or unit dose package. Sirolimus particles or composition thereof may be packed in one or more impermeable container, wherein the first vacuum sealed impermeable container is packed in a second impermeable container and sealed under vacuum.

The impermeable container may further be stored in a rigid container such as non-airtight/air-tight plastic/metal drums, corrugated shipper or fiberboard drum for drug packaging and HDPE (high density polyethylene), PP (polypropylene), LDPE (low density polyethylene), PET, PVC (polyvinyl chloride) bottle for composition packaging.

The vacuum sealed packaging kit may further include an oxygen absorber and/or a moisture absorber. These absorbers may be present in first or both impermeable containers.

Examples of suitable oxygen-absorbers include particulate-type iron (e.g., hydrogen reduced iron, electrolytically reduced iron, atomized iron, and milled pulverized iron powders), copper powder and zinc powder. These oxygen absorbers may be packed in sachets, cartridges or canisters.

Examples of suitable moisture-absorbers include silica gel, clay, molecular sieve, magnesium sulfate, ammonium chloride, calcium oxide, magnesium oxide, barium oxide, barium hydroxide, strontium oxide and aluminum oxide. These moisture absorbers may be packed in sachets or pouches.

The pharmaceutical composition as employed herein includes tablet, capsules, powders or granules. Tablets include conventional tablets or tablets comprising an inert core coated with a sirolimus dispersion.

The pharmaceutical compositions comprise pharmaceutically acceptable excipients, such as sugars, binders, surfactants, diluents, lubricant/glidants, disintegrating agents, antioxidants and coloring agents.

According to one of the embodiments, there is provided a process of packaging sirolimus particles comprising the steps of:
i) placing sirolimus particles into an impermeable bag;
ii) vacuum sealing the bag of step i) and placing the bag into a second impermeable bag; and
iii) vacuum sealing the bag of step ii).

According to another embodiment, there is provided a process of packaging sirolimus particles comprising the steps of:
i) placing sirolimus particles into an impermeable bag;
ii) vacuum sealing the bag of step i) and placing the bag into a second impermeable bag;
iii) vacuum sealing the bag of step ii) along with an oxygen absorber and/or a moisture absorber;
iv) placing the bag of step iii) into a rigid container; and
v) sealing the rigid container of step iv) using heat induction.

According to another embodiment, there is provided a process of packaging a pharmaceutical composition of sirolimus particles comprising the steps of:
i) placing the composition into an impermeable bag;
ii) vacuum sealing the bag of step i) and putting the bag into second impermeable bag; and
iii) vacuum sealing the bag of step ii).

### EXAMPLES

### Example 1

Sirolimus particles (d₉₀-4.1 micron) were packed in a bag made up of laminate having a polyester and a polyethylene layer wherein the layers have a thickness of 12 micron and 75 micron, respectively. The bag was sealed under vacuum. The vacuum sealed bag was put into second bag made up of laminate having polyester, aluminium foil, polyester and polyethylene layer wherein the layers have a thickness of 12 micron, 12 micron, 12 micron and 75 microns, respectively. The second bag was sealed under vacuum and was subjected to stability studies at 25° C. and 60% RH for three months.

Quantitative determination was carried out using Gradient High Performance Liquid Chromatography with a mixture of ammonium phosphate buffer and an organic phase (acetonitrile and tetrahydrofuran) as the mobile phase, ACE C18, HL, 5 μm column as a stationary phase and a UV detector.

TABLE 1
Stability studies of sirolimus particles packed
in an impermeable container of Example 1

| | Initial | Three months |
|---|---|---|
| Impurities | (% w/w) | (% w/w) |
| Isomer A | 0.132 | 0.202 |
| Isomer C | 3.331 | 3.642 |
| Total unknown | 0.384 | 0.519 |

The sirolimus particles were found to be stable at 25° C. and 60% RH even after three months.

We claim:

1. A packaging kit used for the stabilization of sirolimus particles wherein the packaging kit is in the form of a vacuum sealed impermeable container.

2. The packaging kit according to claim 1 wherein the impermeable container is made up of a laminated structure.

3. The packaging kit according to claim 2 wherein the laminated structure comprises an impermeable layer.

4. The packaging kit according to claim 3 wherein the impermeable layer is made up of material selected from the group consisting of bi-axially oriented polypropylene (BOPP), PET (polyethylene terpthalate), oriented polyamide (OPA), aluminum and blends thereof.

5. The packaging kit according to claim 3 wherein the laminated structure further comprises a permeable layer.

6. The packaging kit according to claim 5 wherein the permeable layer is made up of polyethylene.

7. The packaging kit according to claim 1 wherein the impermeable container comprises oxygen and/or a moisture absorber.

8. The packaging kit according to claim 1 wherein the impermeable container is in form of bag or pouch or unit dose pack.

9. The packaging kit according to claim 8 wherein the process for packaging comprises the step of:
a) packaging sirolimus particles into an impermeable bag; and
b) vacuum sealing the bag.

10. The packaging kit according to claim 9 wherein the bag of step b) is put in second impermeable bag along with oxygen and/or moisture absorber.

11. The packaging kit according to claim 10 wherein the second impermeable bag is vacuum sealed and put into a rigid container.
